(19) United States
(12) Patent Application Publication
(10) Pub. No.: US 2016/0179559 A1
(43) Pub. Date: Jun. 23, 2016

(54) INFORMATION PROCESSING APPARATUS AND INFORMATION PROCESSING METHOD

(71) Applicant: Shigeya SENDA, Shizuoka (JP)

(72) Inventor: Shigeya SENDA, Shizuoka (JP)

(21) Appl. No.: 14/972,744

(22) Filed: Dec. 17, 2015

(30) Foreign Application Priority Data
Dec. 17, 2014 (JP) 2014-255586

(51) Int. Cl. G06F 9/455; G06F 17/30

(52) U.S. Cl. CPC G06F 9/45545; G06F 9/45558; G06F 17/30233; G06F 2009/45583

(57) ABSTRACT

An information processing apparatus includes: a first processing unit that operates in a real environment, performs processing after reading first processing-target information into a predetermined memory area of a primary storage unit, and implements a predetermined function in the real environment; and a second processing unit that operates in a virtual environment that is established in the real environment, causes the first processing unit to read second processing-target information into the predetermined memory area of the primary storage unit, processes the second processing-target information read into the predetermined memory area, and implements the predetermined function in the virtual environment.

### CROSS-REFERENCE TO RELATED APPLICATIONS

The present application claims priority to and incorporates by reference the entire contents of Japanese Patent Application No. 2014-255586 filed in Japan on Dec. 17, 2014.

### BACKGROUND OF THE INVENTION

1. Field of the Invention

The present invention relates to an information processing apparatus and an information processing method.

2. Description of the Related Art

Heretofore, virtualization techniques, such as full virtualization or paravirtualization, for operating systems (OSs) have been known (for example, see Japanese Patent Application Laid-open No. 2012-38117).

For example, with the above-described virtualization technique, a guest OS, which operates in the virtual environment that is established in the real environment, implements a file system in the virtual environment and has access to files. In this case, a host OS, which operates in the real environment, receives a designation from the guest OS, reads the target file to be accessed from an external storage device, such as a hard disk drive (HDD), into the cache area for the host OS in the primary storage device, such as a memory and, after the contents in the cache area are copied to the cache area for the guest OS in the memory for synchronization, the guest OS reads the target file to be accessed from the cache area for the guest OS in the memory.

According to the above-described conventional technique, in order to achieve virtualization, there is a need to separately prepare the cache area for the host OS and the cache area for the guest OS and to synchronize the contents in the two cache areas, which results in the occurrence of overheads and an increase in the processing loads.

Therefore, it is desirable to provide an information processing apparatus and an information processing method capable of reducing the processing loads that are caused by virtualization.

### SUMMARY OF THE INVENTION

It is an object of the present invention to at least partially solve the problems in the conventional technology.

According to an aspect of the present invention, there is provided an information processing apparatus including: a first processing unit that operates in a real environment, performs processing after reading first processing-target information into a predetermined memory area of a primary storage unit, and implements a predetermined function in the real environment; and a second processing unit that operates in a virtual environment that is established in the real environment, causes the first processing unit to read second processing-target information into the predetermined memory area of the primary storage unit, processes the second processing-target information read into the predetermined memory area, and implements the predetermined function in the virtual environment.

According to another aspect of the present invention, there is provided an information processing method including: by a first processing unit that operates in a real environment, performing processing after reading first processing-target information into a predetermined memory area of a primary storage unit and implementing a predetermined function in the real environment; and by a second processing unit that operates in a virtual environment that is established in the real environment, causing the first processing unit to read second processing-target information into the predetermined memory area of the primary storage unit, processing the second processing-target information read into the predetermined memory area, and implementing the predetermined function in the virtual environment.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram that illustrates an example of the hardware configuration of an information processing apparatus according to the present embodiment;

FIG. 2 is a block diagram that illustrates an example of the functional configuration of the information processing apparatus according to the present embodiment;

FIG. 3 is a diagram that illustrates an example of the relation among objects according to the present embodiment;

FIG. 4 is a diagram that illustrates an example of the relation between a system call and an object according to the present embodiment; and

FIG. 5 is a sequence diagram that illustrates an example of a file reading operation by a guest OS, performed in the information processing apparatus according to the present embodiment.

### DETAILED DESCRIPTION OF THE PREFERRED EMBODIMENTS

With reference to the attached drawings, a detailed explanation is given below of an embodiment of an information processing apparatus and an information processing method according to the present invention.

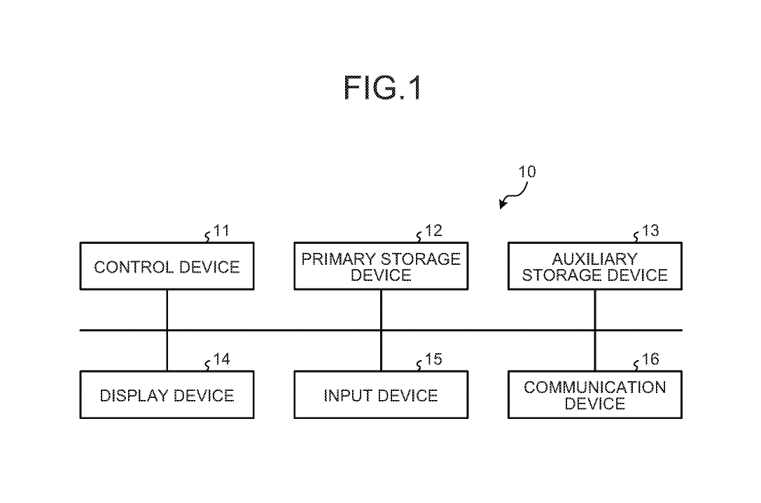

FIG. 1 is a block diagram that illustrates an example of the hardware configuration of an information processing apparatus 10 according to the present embodiment. As illustrated in FIG. 1, the information processing apparatus 10 includes a control device 11, such as a central processing unit (CPU) or a graphics processing unit (GPU); a primary storage device 12, such as a read only memory (ROM) or a random access memory (RAM); an auxiliary storage device 13, such as a hard disk drive (HDD) or a solid state drive (SSD); a display device 14, such as a display; an input device 15, such as a mouse, keyboard, touch panel, or key switch; and a communication device 16, such as a communication interface, and it has the hardware configuration using a typical computer.

However, this is not a limitation on the hardware configuration of the information processing apparatus 10, and it may further include an integrated circuit (IC), an application specific integrated circuit (ASIC), various sensors, or the like.

The information processing apparatus 10 includes, for example, personal computer (PC), smartphone, tablet terminal, wearable terminal, image forming apparatus, projector, teleconference device, electronic blackboard, fluorescent light, camera, air conditioner, refrigerator, automatic dispenser, or industrial equipment. The image forming apparatus includes, for example, a printing device, copier, multifunction peripheral, scanner device, or facsimile machine. The multifunction peripheral has at least two functions out of a copier function, printer function, scanner function, and facsimile function.

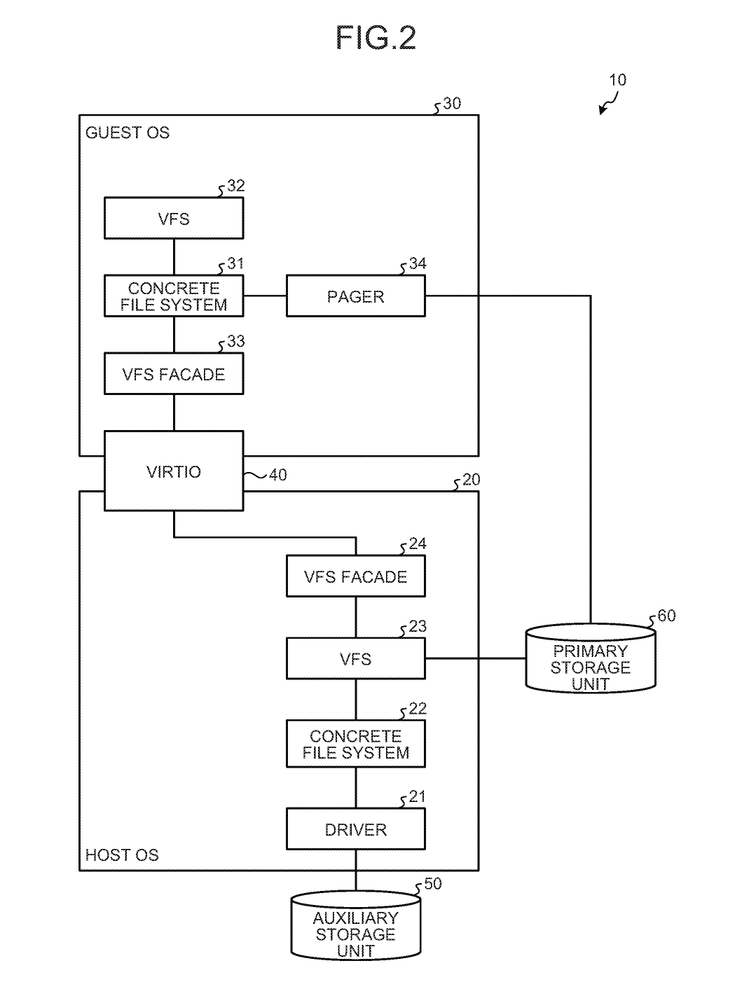

FIG. 2 is a block diagram that illustrates an example of the functional configuration of the information processing apparatus 10 according to the present embodiment. As illustrated in FIG. 2, the information processing apparatus 10 includes a host operating system (OS) 20 (an example of a first processing unit), a guest OS 30 (an example of a second processing unit), Virtio 40, an auxiliary storage unit 50, and a primary storage unit 60.

The host OS 20, the guest OS 30, and the Virtio 40 may be implemented by, for example, the control device 11 and the primary storage device 12, the auxiliary storage unit 50 may be implemented by, for example, the auxiliary storage device 13, and the primary storage unit 60 may be implemented by, for example, the primary storage device 12.

The host OS 20 is the OS that operates in the real environment of the information processing apparatus 10. The real environment is the computer environment that is physically established by the hardware. Specifically, the host OS 20 is the infrastructure OS of the information processing apparatus 10, and it operates the virtual machine (VM) that is the software for establishing the virtual environment to operate the guest OS 30.

Furthermore, in the present embodiment, an explanation is given of a case where, for example, the host OS 20 is a LINUX (registered trademark) or Berkeley Software Distribution (BSD)-derived OS, or the like, which is an OS that includes a buffer cache, page cache, virtual file system (VFS), or the like; however, this is not a limitation and, it may be different OSs that have the function equivalent to a buffer cache, page cache, or VFS.

The guest OS 30 is the OS that operates in the virtual environment that is established in the real environment of the information processing apparatus 10. The virtual environment is the computer environment that is virtually established by the VM that is operated in the host OS 20. Specifically, the guest OS 30 is the OS that is operated in a virtual machine (the host OS 20).

The Virtio 40 is the interface for implementing an inter-VM communication between the host OS 20 and the guest OS 30. However, this is not a limitation and, for example, if Xen is used for the VM, XenSocket may be used as the interface for implementing the inter-VM communication, or the interface that is uniquely provided by a vendor may be used as the interface for implementing the inter-VM communication.

The auxiliary storage unit 50 stores multiple pieces of information relating to the file system. The information relating to the file system includes one or more pieces of real management information for managing, in the real environment, one or more files and one or more directories that constitute the file system, one or more pieces of virtual management information for managing, in the virtual environment, one or more files and one or more directories that constitute the file system and, with regard to each of one or more files, the file information that is the information on the file itself.

One or more pieces of real management information include the meta-information (e.g., super block) on the file system itself in the real environment, inode that is the basic information relating to an object (e.g., file or directory) of the file system in the real environment, dentry for relating inode with a directory entry (e.g., file path information) of the file system in the real environment, or the like. Here, inode may be vnode that is further abstraction of inode.

One or more pieces of virtual management information include the meta-information on the file system itself in the virtual environment, inode that is the basic information relating to an object of the file system in the virtual environment, dentry for relating inode with a directory entry of the file system in the virtual environment, or the like. Here, inode may be vnode that is further abstraction of inode. Furthermore, contrary to dentry of the real management information, dentry of the virtual management information is the path that includes the mount point of the guest OS 30.

The primary storage unit 60 has a predetermined memory area. The predetermined memory area is a cache area where the processing-target information is cached from the auxiliary storage unit 50, and it includes a buffer cache area where the real management information or the virtual management information is cached, or a page cache area where the file information is cached. Furthermore, according to the present embodiment, the host OS 20 and the guest OS 30 share the predetermined memory area. That is, the predetermined memory area is not prepared for each of the host OS 20 and the guest OS 30, but it is commonly prepared for the host OS 20 and the guest OS 30.

The host OS 20 performs processing after reading the first processing-target information into the predetermined memory area of the primary storage unit 60 and performs a predetermined function in the real environment. In the present embodiment, an explanation is given of a case where, for example, the predetermined function is a file system; however, this is not a limitation, and different functions of the host OS 20 may be applied in the same manner.

If the predetermined function is the file system, the host OS 20 caches the first processing-target information, which is any one of the pieces of information relating to the file system, into the predetermined memory area of the primary storage unit 60 from the auxiliary storage unit 50 and accesses the first processing-target information, which is cached in the predetermined memory area, thereby having access to the file system in the real environment. Furthermore, the first processing-target information includes, for example, the real management information or the file information.

Here, an explanation is given of the detailed configuration of the host OS 20. As illustrated in FIG. 2, the host OS 20 includes a driver 21, a concrete file system 22, a VFS 23, and a VFS facade 24.

The driver 21 is a device driver for controlling the auxiliary storage unit 50. The concrete file system 22 is the file system (e.g., extfs or ufs) that directly handles the file system in the real environment (in the auxiliary storage unit 50), and the VFS 23 is the file system that abstracts the concrete file system 22 so as to handle it in an integrated manner. The VFS facade 24 is the interface for operating the VFS 23 from the guest OS 30.

For example, a process (not illustrated) of the host OS 20 designates an access to a certain directory so that the inode of the certain directory is notified to the VFS 23. In this case, the notified inode is the inode of the real management information. The VFS 23 causes the concrete file system 22 to access the auxiliary storage unit 50 via the driver 21, read the inode and the dentry of a directory or file that is located under the certain directory from one or more pieces of real management information on the basis of the notified inode, and cache them in the predetermined memory area (specifically, the buffer cache area) of the primary storage unit 60. Furthermore, if the inode and the dentry have been already cached in the predetermined memory area of the primary storage unit 60, the above operation is omitted. Then, the VFS 23 accesses (reads) the inode and the dentry that are cached in the predetermined memory area and returns them to the process of the host OS 20, thereby having access to the directory of the file system in the real environment.

Furthermore, for example, a process (not illustrated) of the host OS 20 designates an access to a certain file so that the inode of the certain file is notified to the VFS 23. In this case, the notified inode is the inode of the real management information. The VFS 23 causes the concrete file system 22 to access the auxiliary storage unit 50 via the driver 21, read the file information on the certain file from one or more pieces of real management information on the basis of the notified inode, and cache it in the predetermined memory area (specifically, the page cache area) of the primary storage unit 60. Furthermore, if the file information has been already cached in the predetermined memory area of the primary storage unit 60, the above operation is omitted. Then, the VFS 23 accesses (reads) the file information, which is cached in the predetermined memory area, and returns it to the process of the host OS 20, thereby having access to the file of the file system in the real environment.

The guest OS 30 causes the host OS 20 to read the second processing-target information into the predetermined memory area of the primary storage unit 60, processes the second processing-target information, which has been read into the predetermined memory area, and performs a predetermined function in the virtual environment. In the present embodiment, an explanation is given of a case where, for example, the predetermined function is a file system, as described above; however, this is not a limitation, and different functions of the guest OS 30 may be applied in the same manner.

If the predetermined function is the file system, the guest OS 30 causes the host OS 20 to cache the second processing-target information, which is any one of the pieces of information relating to the file system, into the predetermined memory area of the primary storage unit 60 from the auxiliary storage unit 50, accesses the second processing-target information, which has been cached in the predetermined memory area, and has access to the file system in the virtual environment. Furthermore, the second processing-target information includes, for example, the virtual management information or the file information.

Specifically, the guest OS 30 converts the virtual management information, which is the second processing-target information, into the real management information and, by using the real management information, causes the host OS 20 to cache the second processing-target information into the predetermined memory area of the primary storage unit 60 from the auxiliary storage unit 50. Then, the guest OS 30 acquires, from the host OS 20, the physical address of the predetermined memory area, where the second processing-target information is cached, and uses the physical address to access the second processing-target information that is cached in the predetermined memory area.

Here, an explanation is given of the detailed configuration of the guest OS 30. As illustrated in FIG. 2, the guest OS 30 includes a concrete file system 31, a VFS 32, a VFS facade 33, and a Pager 34.

The concrete file system 31 is a file system that directly handles the file system in the virtual environment (in the VM), and it is operated as a type of concrete file system in the same manner as a typical file system or a shared file system, such as a network file system (NFS).

The VFS 32 is the file system that abstracts the concrete file system 31 so as to handle it in an integrated manner. Specifically, a group of concrete handling functions is prepared for each of the concrete file systems 31 and, by using the group of concrete handling functions, the corresponding concrete file system 31 is operated. Here, the group of concrete handling functions includes a handling function for a super block, a handling function for inode, a handling function for the address space, or the like.

The VFS facade 33 is the module for operating the VFS 23 of the host OS 20 from the guest OS 30. Here, to operate the VFS 23 of the host OS 20 from the guest OS 30, there is a need to designate an operation, intended for an object of the file system in the real environment. Therefore, the VFS facade 33 converts the virtual management information on the object of the file system in the virtual environment into the real management information on the object of the file system in the real environment, thereby performing the operation. Conversion from the virtual management information into the real management information may be conducted by using a dedicated conversion function.

The Pager 34 is a module for writing and reading data to and from the predetermined memory area of the primary storage unit 60. Here, the Pager 34 acquires the physical address of the predetermined memory area from the host OS 20, maps it to the memory space of the guest OS 30 (specifically, registers it in a look-up table other than the paging memory management area of the guest OS 30) and, by using the logical address that is related to the physical address in the memory space, reads data from the predetermined memory area of the primary storage unit 60. Furthermore, according to the present embodiment, it is assumed that the guest OS 30 is familiar with the behavior for managing the predetermined memory area of the primary storage unit 60 by the host OS 20 while the physical address is acquired, and damages to the memory, or the like, do not occur.

For example, a process (not illustrated) of the guest OS 30 designates an access to a certain directory so that the inode and the dentry of the certain directory are notified to the VFS 32. In this case, the notified inode and dentry are the inode and the dentry of the virtual management information. When the VFS facade 33 receives a notification of the inode and the dentry from the VFS 32 via the concrete file system 31, it converts the notified dentry of the virtual management information into the dentry of the real management information by using a dedicated conversion function. Here, as the dentry of the virtual management information includes the notified inode, it is possible to also determine the inode of the real management information, which is a conversion from the notified inode of the virtual management information, from the converted dentry of the real management information. Furthermore, the VFS facade 33 performs an inter-VM communication via the Virtio 40 and notifies the converted inode to the VFS 23 via the VFS facade 24 of the host OS 20.

The VFS 23 causes the concrete file system 22 to access the auxiliary storage unit 50 via the driver 21, read the inode and the dentry of a directory or file that is located under the certain directory from one or more pieces of real management information on the basis of the notified inode, and cache them in the predetermined memory area (specifically, the buffer cache area) of the primary storage unit 60. Furthermore, if the inode and the dentry have been already cached in the predetermined memory area of the primary storage unit 60, the above operation is omitted. Then, the VFS 23 causes the VFS facade 24 to perform an inter-VM communication via the Virtio 40 and notifies the concrete file system 31 via the VFS facade 33 of the guest OS 30 of the physical address of the predetermined memory area where the inode and the dentry of a directory or file, located under the certain directory, are cached.

The concrete file system 31 notifies the physical address to the Pager 34, and the Pager 34 uses the physical address to access (read) the inode and the dentry, which are cached in the predetermined memory area of the primary storage unit 60, and returns them to the process of the guest OS 30, thereby having access to the directory of the file system in the virtual environment.

Furthermore, for example, a process (not illustrated) of the guest OS 30 designates an access to a certain file so that the inode and the dentry of the certain file are notified to the VFS 32. In this case, the notified inode and dentry are the inode and the dentry of the virtual management information. When the VFS facade 33 receives a notification of the inode and the dentry from the VFS 32 via the concrete file system 31, it converts the notified dentry of the virtual management information into the dentry of the real management information by using a dedicated conversion function. Here, as the dentry of the virtual management information includes the notified inode, it is possible to also determine the inode of the real management information, which is a conversion from the notified inode of the virtual management information, from the converted dentry of the real management information. Furthermore, the VFS facade 33 performs an inter-VM communication via the Virtio 40 and notifies the converted inode to the VFS 23 via the VFS facade 24 of the host OS 20.

The VFS 23 causes the concrete file system 22 to access the auxiliary storage unit 50 via the driver 21, read the file information on the certain file from one or more pieces of real management information on the basis of the notified inode, and cache them in the predetermined memory area (specifically, the buffer cache area) of the primary storage unit 60. Furthermore, if the file information has been already cached in the predetermined memory area of the primary storage unit 60, the above operation is omitted. Then, the VFS 23 causes the VFS facade 24 to perform an inter-VM communication via the Virtio 40 and notifies the concrete file system 31 via the VFS facade 33 of the guest OS 30 of the physical address of the predetermined memory area where the file information on the certain file is cached.

The concrete file system 31 notifies the physical address to the Pager 34, and the Pager 34 uses the physical address to access (read) the file information, which is cached in the predetermined memory area of the primary storage unit 60, and returns it to the process of the guest OS 30, thereby having access to the file of the file system in the virtual environment.

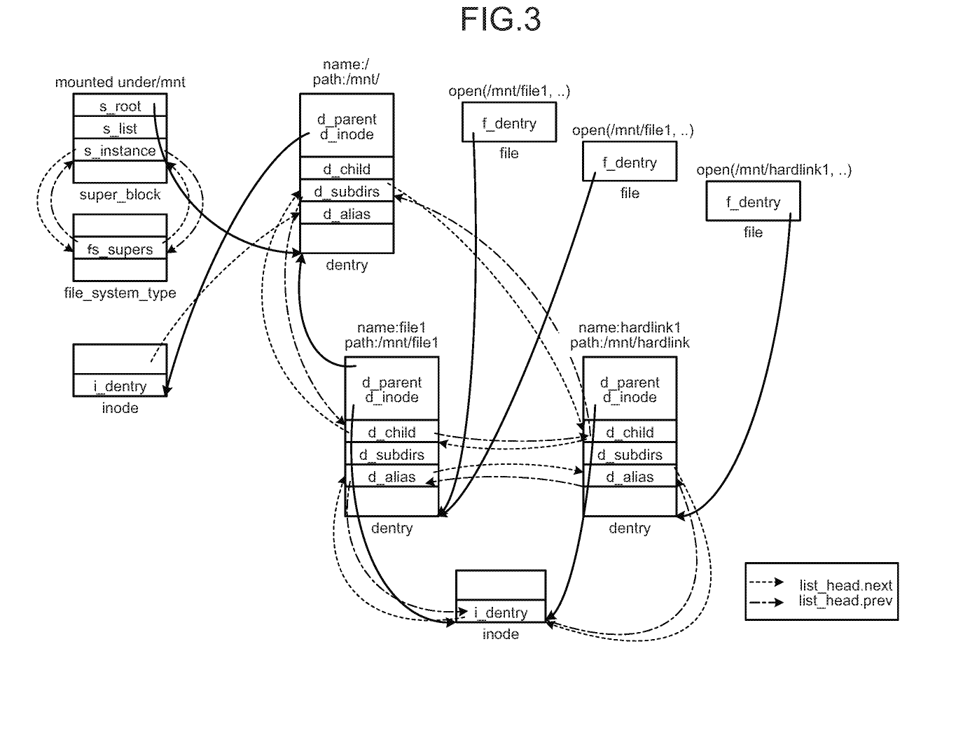

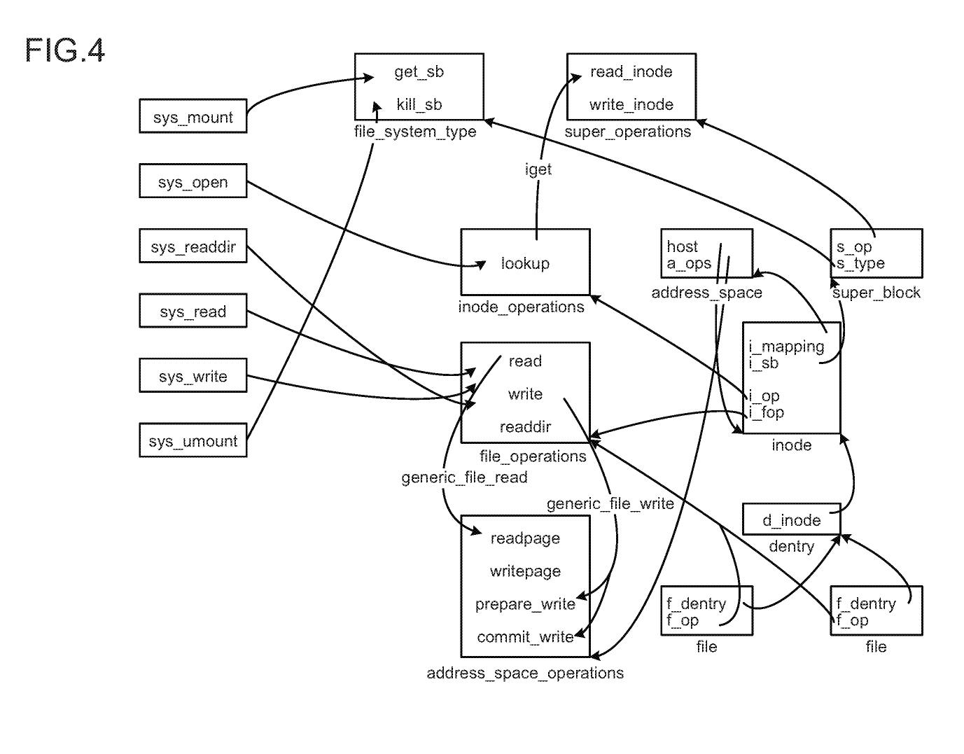

FIGS. 3 and 4 are examples of the operation explanatory diagrams in a case where the guest OS 30 reads a file; FIG. 3 illustrates an example of the diagram of the relation among objects, and FIG. 4 illustrates an example of the relation between a system call and an object.

For example, if a process of the guest OS 30 calls sys_read( ) of the system call to invoke a certain file, the concrete file system 31 of the guest OS 30 calls read( ) that is in file_operations. Furthermore, if generic_file_read( ) is registered in reality, the concrete file system 31 calls generic_file_read( ).

As a result, the VFS facade 33 of the host OS 20 calls readpage( ) that is registered in address space operations structure. Furthermore, the pointer of inode, which is a variable of readpage( ) is converted into the pointer of inode of the real management information by the VFS facade 33 of the guest OS 30.

Thus, the concrete file system 22 of the host OS 20 refers to i_fop of inode of the real management information, determines the specific read position of the certain file, and reads the file information on the certain file from the auxiliary storage unit 50, and the VFS 23 of the host OS 20 caches it in the predetermined memory area of the primary storage unit 60 and returns, to the guest OS 30, the physical address of the predetermined memory area where the file information is cached.

Furthermore, if the file information has been already cached in the predetermined memory area of the primary storage unit 60, the operation for caching to the predetermined memory area is not performed, and the physical address of the predetermined memory area where the file information has been already cached is returned to the guest OS 30.

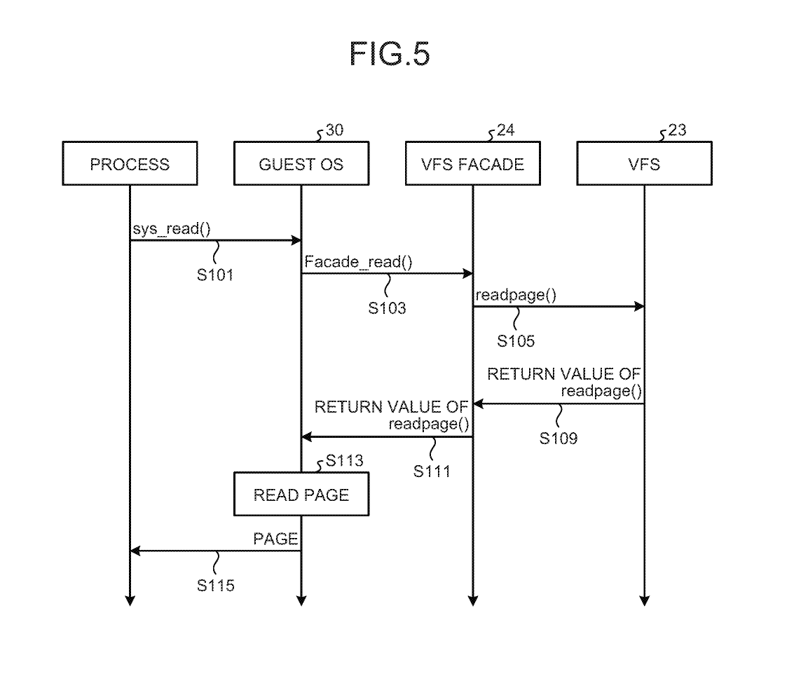

FIG. 5 is a sequence diagram that illustrates an example of a file reading operation by the guest OS 30, performed in the information processing apparatus 10 according to the present embodiment.

First, a process of the guest OS 30 calls sys_read( ) of the system call for invoking a certain file (Step S101).

Next, when sys_read( ) is called, the concrete file system 31 of the guest OS 30 calls read( ) that is in file_operations, and the VFS facade 33 of the guest OS 30 converts the pointer of inode, which is a variable of read( ) into the pointer of inode of the real management information and calls Facade_read( ) (Step S103).

Then, when Facade_read( ) is called, the VFS facade 24 of the host OS 20 calls readpage( )(Step S105).

Next, when readpage( ) is called, the VFS 23 of the host OS 20 causes the concrete file system 22 of the host OS 20 to read the page that is the file information on the certain file from the auxiliary storage unit 50, caches it in the predetermined memory area of the primary storage unit 60, and returns the physical address of the predetermined memory area, where the page is cached, as a return value to the VFS facade 24 (Step S109).

Next, the VFS facade 24 returns the return value of readpage( ) to the guest OS 30 (Step S111).

Then, the Pager 34 of the guest OS 30 uses the return value of readpage( ) to read the page that is cached in the predetermined memory area of the primary storage unit 60 (Step S113) and returns it to the process of the guest OS (Step S115).

As described above, according to the present embodiment, the cache area for the host OS and the cache area for the guest OS are shared, and there is no need to synchronize the contents of the two cache areas; therefore, it is possible to prevent the occurrence of overhead due to synchronization and to reduce the processing loads that are caused by virtualization.

Program

The program that is executed by the information processing apparatus 10 according to the above-described embodiment is provided by being stored, in the form of a file that is installable and executable, in a recording medium readable by a computer, such as a CD-ROM, a CD-R, a memory card, a digital versatile disk (DVD), or a flexible disk (FD).

Furthermore, the program that is executed by the information processing apparatus 10 according to the above-described embodiment may be stored in a computer, connected via a network such as the Internet, and provided by being downloaded via the network. Furthermore, the program that is executed by the information processing apparatus 10 according to the above-described embodiment may be provided or distributed via a network such as the Internet. Moreover, the program that is executed by the information processing apparatus 10 according to the above-described embodiment may be provided by being previously installed in a ROM, or the like.

The program that is executed by the information processing apparatus 10 according to the above-described embodiment has a modular configuration for implementing the above-described units in the computer. In terms of actual hardware, for example, the CPU reads the program from the ROM into a RAM and executes it, thereby implementing the above-described functional units in the computer.

According to the present embodiments, an advantage is produced such that the processing loads due to virtualization may be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first processing unit that operates in a real environment, performs processing after reading first processing-target information into a predetermined memory area of a primary storage unit, and implements a predetermined function in the real environment; and
a second processing unit that operates in a virtual environment that is established in the real environment, causes the first processing unit to read second processing-target information into the predetermined memory area of the primary storage unit, processes the second processing-target information read into the predetermined memory area, and implements the predetermined function in the virtual environment.

2. The information processing apparatus according to claim 1, further comprising an auxiliary storage unit that stores multiple pieces of information relating to a file system, the predetermined function being the file system, wherein
the first processing-target information is at least any of the multiple pieces of information,
the second processing-target information is at least any of the multiple pieces of information,
the first processing unit caches the first processing-target information in the predetermined memory area from the auxiliary storage unit, accesses the first processing-target information cached in the predetermined memory area, and implements access to the file system in the real environment, and
the second processing unit causes the first processing unit to cache the second processing-target information in the predetermined memory area from the auxiliary storage unit, accesses the second processing-target information cached in the predetermined memory area, and implements access to the file system in the virtual environment.

3. The information processing apparatus according to claim 2, wherein
the information relating to the file system includes, for each of one or more files, file information that is information on the file itself,
the first processing-target information is any of one or more pieces of the file information, and
the second processing-target information is any of one or more pieces of the file information.

4. The information processing apparatus according to claim 2, wherein
the information relating to the file system includes one or more pieces of real management information for managing, in the real environment, one or more files and one or more directories that constitute the file system and includes one or more pieces of virtual management information for managing, in the virtual environment, one or more files and one or more directories that constitute the file system,
the first processing-target information is any of the one or more pieces of real management information, and
the second processing-target information is any of the one or more pieces of virtual management information.

5. The information processing apparatus according to claim 4, wherein the second processing unit converts virtual management information of the second processing-target information, into real management information and, by using the real management information, causes the first processing unit to cache the second processing-target information in the predetermined memory area from the auxiliary storage unit.

6. The information processing apparatus according to claim 5, wherein the second processing unit acquires, from the first processing unit, a physical address of the predetermined memory area, in which the second processing-target information is cached, and uses the physical address to access the second processing-target information that is cached in the predetermined memory area.

7. An information processing method comprising:
by a first processing unit that operates in a real environment, performing processing after reading first processing-target information into a predetermined memory area of a primary storage unit and implementing a predetermined function in the real environment; and
by a second processing unit that operates in a virtual environment that is established in the real environment, causing the first processing unit to read second processing-target information into the predetermined memory area of the primary storage unit, processing the second processing-target information read into the predetermined memory area, and implementing the predetermined function in the virtual environment.
